(19) United States
(12) Patent Application Publication
(10) Pub. No.: US 2006/0043029 A1
(43) Pub. Date: Mar. 2, 2006

(54) Continuous liquid delivery system with anti-clog function

(75) Inventors: Chih-Tien Chang, Hsinchu City (TW); Cheng-Husn Chan, Hsin chu County (TW); Bing-Hung Chen, Hualien (TW); Hsueh-Chang Wu, Taipei (TW); Mei-Sheng Zhou, Singapore (SG)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/931,123

(22) Filed: Aug. 30, 2004

(51) Int. Cl. B01D 29/66

(52) U.S. Cl. 210/798; 210/411

(57) ABSTRACT

A continuous liquid delivery system which includes at least one primary filter and at least one secondary filter for alternatively receiving a liquid such as a CMP polishing slurry. A primary backwash circuit is provided in fluid communication with each primary filter for backwashing of the primary filter. At least one secondary backwash circuit is provided in fluid communication with each secondary filter for backwashing of the secondary filter. As the liquid is distributed through the primary filter or filters, the secondary filter or filters can be backwashed, and vice-versa to facilitate a continuous flow of the liquid from a source to a destination.

### FIELD OF THE INVENTION

The present invention relates to systems for distributing liquids. More particularly, the present invention relates to a new and improved liquid delivery system with anti-clog function which is particularly adaptable for the delivery of CMP polishing slurry to a CMP apparatus.

### BACKGROUND OF THE INVENTION

Apparatus for polishing thin, flat semiconductor wafers are well-known in the art. Such apparatus normally includes a polishing head which carries a membrane for engaging and forcing a semiconductor wafer against a wetted polishing surface, such as a polishing pad. Either the pad or the polishing head is rotated and oscillates the wafer over the polishing surface. The polishing head is forced downwardly onto the polishing surface by a pressurized air system or similar arrangement. The downward force pressing the polishing head against the polishing surface can be adjusted as desired. The polishing head is typically mounted on an elongated pivoting carrier arm, which can move the pressure head between several operative positions. In one operative position, the carrier arm positions a wafer mounted on the pressure head in contact with the polishing pad. In order to remove the wafer from contact with the polishing surface, the carrier arm is first pivoted upwardly to lift the pressure head and wafer from the polishing surface. The carrier arm is then pivoted laterally to move the pressure head and wafer carried by the pressure head to an auxiliary wafer processing station. The auxiliary processing station may include, for example, a station for cleaning the wafer and/or polishing head, a wafer unload station, or a wafer load station.

More recently, chemical-mechanical polishing (CMP) apparatus has been employed in combination with a pneumatically-actuated polishing head. CMP apparatus is used primarily for polishing the front face or device side of a semiconductor wafer during the fabrication of semiconductor devices on the wafer. A wafer is “planarized” or smoothed one or more times during a fabrication process in order for the top surface of the wafer to be as flat as possible. A wafer is polished by being placed on a carrier and pressed face down onto a polishing pad covered with a slurry of colloidal silica or alumina in deionized water.

CMP polishing results from a combination of chemical and mechanical effects. A possible mechanism for the CMP process involves the formation of a chemically altered layer at the surface of the material being polished. The layer is mechanically removed from the underlying bulk material. An altered layer is then regrown on the surface while the process is repeated again. For instance, in metal polishing, a metal oxide may be formed and removed separately. The chemical mechanical polishing method can be used to provide a planar surface on dielectric layers, on deep and shallow trenches that are filled with polysilicon or oxide, and on various metal films.

Referring initially to FIG. 1, a conventional CMP apparatus 50 includes a conditioning head 52, a polishing pad 56, and a slurry delivery arm 54 positioned over the polishing pad 56. The conditioning head 52 is mounted on a conditioning arm 58 which is extended over the top of the polishing pad 56 for making a sweeping motion across the entire surface of the polishing pad 56. The slurry delivery arm 54 is equipped with slurry dispensing nozzles 62 which are used for dispensing a slurry solution on the top surface 60 of the polishing pad 56. Surface grooves 64 are further provided in the top surface 60 to facilitate even distribution of the slurry solution and to help entrapping undesirable particles that are generated by coagulated slurry solution or any other foreign particles which have fallen on top of the polishing pad 56 during a polishing process. The surface grooves 64, while serving an important function of distributing the slurry, also presents a processing problem when the pad surface 60 gradually wears out after prolonged use.

A typical conventional CMP system 10 is shown in FIG. 2 and includes a slurry delivery system 12 which is confluently connected to a CMP apparatus 30. A pump 18 pumps polishing slurry from a slurry supply 14 and through a slurry filter 16. The slurry flows through a first valve 20, which may be operated by pressurized deionized water from a DI water supply 22, and through a second filter 24 to a pump 26. The slurry is typically stored in a slurry reservoir 28 prior to being pumped to the CMP apparatus 30.

As the polishing slurry flows through the slurry filter 16, extraneous particles are removed from the slurry. However, due to the high viscosity of the slurry and large variations in size of the particles in the slurry, the slurry filter 16 frequently becomes clogged with the removed particles. Consequently, the slurry filter 16 must be replaced typically every 2˜7 days. This contributes to high operational cost, is labor-intensive and adversely impacts the CMP process performance. Moreover, since the conventional system 10 includes only one slurry delivery line, the CMP process must be halted during replacement of the slurry filter. Accordingly, a new and improved slurry delivery and filtering system is needed which facilitates the continuous flow of slurry to a CMP apparatus and which substantially prolongs the lifetime of a slurry filter or filters.

An object of the present invention is to provide a new and improved, continuous liquid delivery system which can be adapted to distribute any of a variety of liquids.

Another object of the present invention is to provide a new and improved, continuous liquid delivery system which can be adapted to deliver polishing slurry from a slurry reservoir to a CMP apparatus.

Still another object of the present invention is to provide a new and improved, continuous liquid delivery system which is capable of substantially prolonging the functional lifetime of a liquid filter or filters.

Yet another object of the present invention is to provide a new and improved, continuous liquid delivery system which facilitates the cleaning or replacement of one set of filters while permitting delivery of a liquid through another set of filters to facilitate a continuous and uninterrupted flow of the liquid.

A still further object of the present invention is to provide a continuous liquid delivery system which may include a pair of separate liquid delivery lines, each having one or multiple filters and a system of valves to facilitate grouped or individual backwashing of a filter or filters in one liquid delivery line while permitting the flow of liquid through the other liquid delivery line.

Yet another object of the present invention is to provide a continuous liquid delivery system which substantially reduces costs and labor associated with replacing a liquid filter or filters.

### SUMMARY OF THE INVENTION

In accordance with these and other objects and advantages, the present invention is generally directed to a new and improved, continuous liquid delivery system for delivering and filtering liquids. The continuous liquid delivery system is particularly adaptable to the filtering and delivery of polishing slurry from a slurry reservoir to a CMP apparatus in the polishing of semiconductor wafer substrates. The continuous liquid delivery system includes primary and secondary liquid delivery lines, each provided with at least one filter and provided in fluid communication with each other. A water inlet line and a water outlet line, each provided with a valve, are provided in fluid communication with each liquid delivery line, on the respective sides of each filter.

The continuous liquid delivery system is capable of delivering a liquid through either the primary liquid delivery line or the secondary liquid delivery line. When cleaning of the filter or filters in the primary liquid delivery line is necessary, the liquid is distributed through the secondary liquid delivery line. Simultaneously, deionized water or other cleaning fluid is distributed, in the reverse direction, through the filter in the primary liquid delivery line using the water inlet line and the water outlet line, thus backwashing particles from the filter. Each filter in the primary liquid delivery line is typically filtered individually.

After backwashing of the filter or filters in the primary liquid delivery line is completed, the primary liquid delivery line is subjected to a purification step in which deionized water or other cleaning fluid is distributed through the primary liquid delivery line, including the filter or filters therein, to dislodge any remaining particles from the filters and the line. Delivery of the liquid through the primary liquid delivery line is then resumed, at which time the secondary liquid delivery line is cleaned in the same manner as was the primary liquid delivery line. In this manner, the liquid is continuously delivered from a source to a destination and filtered while simultaneously permitting cleaning or unclogging of a filter or filters in the liquid delivery system.

### BRIEF DESCRIPTION OF THE DRAWINGS

The invention will now be described, by way of example, with reference to the accompanying drawings, in which:

FIG. 1 is a perspective view of a typical conventional CMP apparatus;

FIG. 2 is a schematic of a typical conventional CMP system which includes a polishing slurry delivery system;

FIG. 3 is a schematic of an illustrative embodiment of the continuos liquid delivery system of the present invention;

FIG. 4A is a schematic of the continuous liquid delivery system, illustrating delivery of a liquid through a primary liquid delivery line;

FIG. 4B is a schematic of the continuous liquid delivery system, illustrating backwashing of a filter in the primary liquid delivery line during delivery of a liquid through a secondary liquid delivery line;

FIG. 4C is a schematic of the continuous liquid delivery system, illustrating backwashing of a second filter in the primary liquid delivery line during delivery of the liquid through the secondary liquid delivery line;

FIG. 4D is a schematic of the continuous liquid delivery system, illustrating purification of the primary liquid delivery line during delivery of the liquid through the secondary liquid delivery line;

FIG. 5 is a cross-section of a filter element of the continuous liquid delivery system, illustrating clogging of the filter; and

FIGS. 6A-6D are cross-sectional views of a filter element of the continuous liquid delivery system, illustrating back-and-forth flow of water through the filter in a backwash cycle to dislodge clogged impurities from the filter.

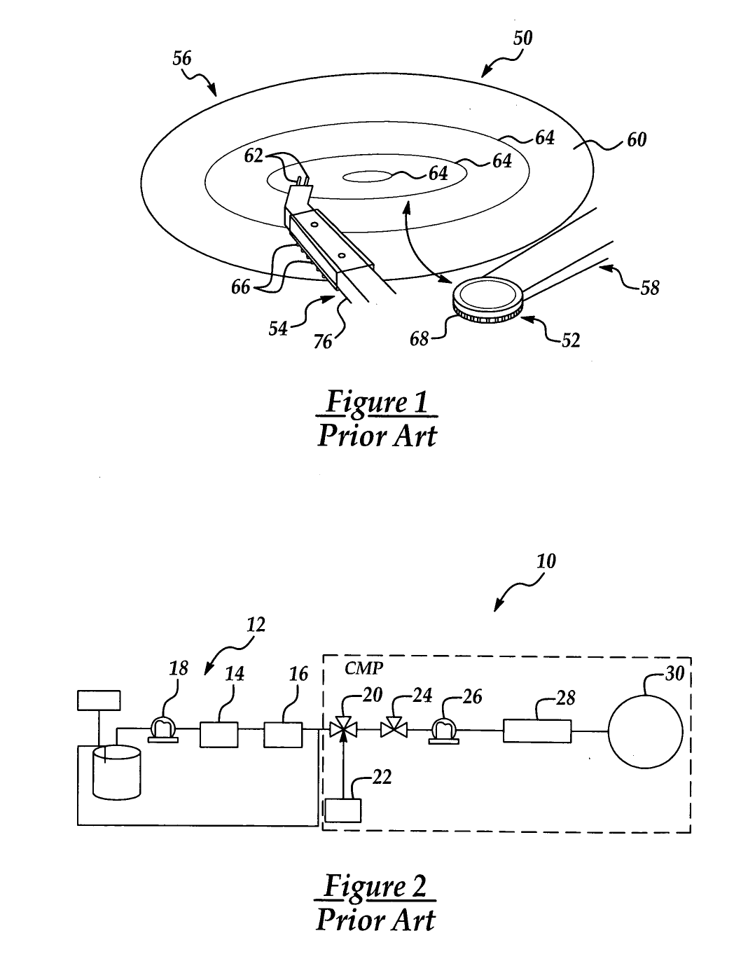

### DETAILED DESCRIPTION OF THE INVENTION

The present invention has particularly beneficial utility in the continuous delivery of polishing slurry from a slurry supply or reservoir to a chemical mechanical planarization (CMP) apparatus used to polish layers on a semiconductor wafer substrate. However, the invention is not so limited in application, and while references may be made to such polishing slurry and CMP apparatus, the invention is more generally applicable to facilitating the continuous delivery of liquids in a variety of industrial applications.

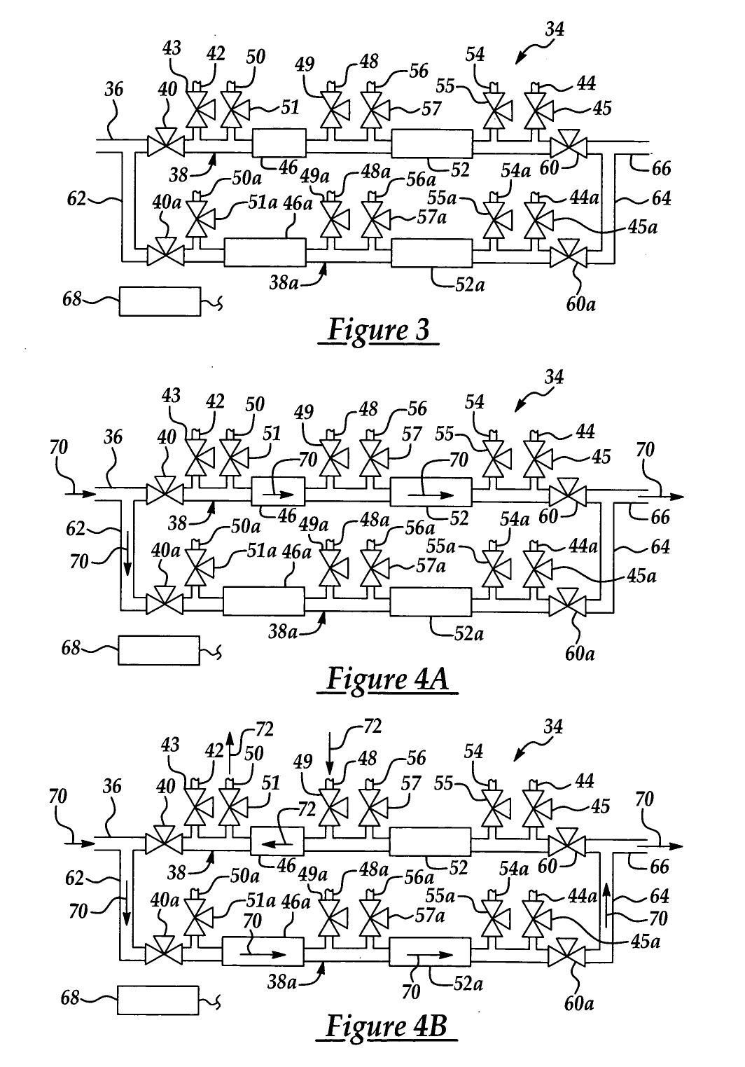

Referring initially to FIG. 3, an illustrative embodiment of the continuous liquid delivery system of the present invention is generally indicated by reference numeral 34. The system 34 includes a liquid source line 36 which is connected to a source (not shown) of liquid to be distributed through the system 34 to a destination (not shown). For example, the liquid source line 36 may be connected to a supply of polishing slurry for the delivery and filtering of polishing slurry through the system 34 and to a CMP apparatus (not shown). A primary liquid delivery line 38, in which is provided a primary course filter 46 and a primary fine filter 52, is confluent with the liquid source line 36. A secondary liquid delivery line 38a, in which is provided a secondary course filter 46a and a secondary fine filter 52a, is confluent with a liquid shunt line 62 which branches from the liquid source line 36.

As used herein, the terms, “upstream” and “downstream” shall be construed to mean upstream and downstream, respectively, with respect to the normal flow direction of the liquid to be filtered and distributed through the system 34 as the liquid flows and is filtered through the system 34.

A primary entrance valve 40 is provided in the inlet end of the primary liquid delivery line 38. The course filter 46 is typically provided in the primary liquid delivery line 38 downstream of the primary entrance valve 40, for the filtering of course particles from a liquid. The fine filter 52 is typically further provided in the primary liquid delivery line 38 downstream of the course filter 46, for the filtering of fine particles from the liquid. However, the primary liquid delivery line 38 may include one or any desired number of filters, depending on the particular application of the system 34. A primary exit valve 60 is provided in the downstream end of the primary liquid delivery line 38.

A primary purification inlet line 42, fitted with a valve 43, extends into the primary liquid delivery line 38 adjacent to the entrance valve 40. A primary purification outlet line 44, fitted with a valve 45, extends from the primary liquid delivery line 38 adjacent to the exit valve 60. A source (not shown) of deionized water or other cleaning fluid is provided in confluent relationship with the purification inlet line 42 to facilitate flushing of the primary liquid delivery line 38, typically with flushing deionized water, as hereinafter described. The flushing water exits the primary liquid delivery line 38 typically through the purification outlet line 44.

A primary course filter inlet line 48, fitted with a primary valve 49, extends into the primary liquid delivery line 38, downstream of the course filter 46. A primary course filter outlet line 50, fitted with a primary valve 51, extends from the primary liquid delivery line 38, upstream of the course filter 46. The course filter inlet line 48 is confluently attached to a backwash water source (not shown) to facilitate the flow of backwash deionized water or cleaning fluid through the course filter inlet line 48 and course filter 46, and from the primary liquid delivery line 38 through the course filter outlet line 50, to facilitate the removal of clogging particles from the course filter 46, as hereinafter described. Accordingly, the primary course filter inlet line 48 and primary course filter outlet line 50 form a backwash circuit for backwashing of the primary course filter 46.

A primary fine filter inlet line 54, fitted with a primary valve 55, extends into the primary liquid delivery line 38, downstream of the primary fine filter 52. A primary fine filter outlet line 56, fitted with a primary valve 57, extends from the primary liquid delivery line 38, upstream of the fine filter 52. The fine filter inlet line 54 is confluently attached to a backwash water source (not shown) to facilitate the flow of backwash deionized water or cleaning fluid through the fine filter inlet line 54 and fine filter 52, and from the primary liquid delivery line 38 through the fine filter outlet line 56. This facilitates the removal of clogging particles from the fine filter 52, as hereinafter described.

A secondary course filter inlet line 48a, fitted with a secondary valve 49a, and a secondary course filter outlet line 50a, fitted with a secondary valve 51a, are confluently attached to the secondary liquid delivery line 38a, at the downstream and upstream ends, respectively, of the secondary course filter 46a. A secondary fine filter inlet line 54a, fitted with a secondary valve 55a, and a secondary fine filter outlet line 56a, fitted with a secondary valve 57a, are confluently attached to the secondary liquid delivery line 38a, at the downstream and upstream ends, respectively, of the secondary fine filter 52a. Accordingly, the secondary course filter inlet line 48a and the secondary course filter outlet line 50a of the secondary liquid delivery line 38a are functional equivalents of the primary course filter inlet line 48 and the primary course filter outlet line 50 of the primary liquid delivery line 38, respectively, and are used to backwash the secondary course filter 46a, in the manner hereinafter described. Similarly, the secondary fine filter inlet line 54a and the secondary fine filter outlet line 56a are functional equivalents of the primary fine filter inlet line 54 and the primary fine filter outlet line 56, respectively, of the primary liquid delivery line 38, and are used to backwash the secondary fine filter 52a, in the manner hereinafter described.

A shunt return line 64 extends from the discharge end of the secondary liquid delivery line 38a and enters the discharge end of the primary liquid delivery line 38. A main outlet line 66 extends beyond the shunt return line 64 and leads to the destination of the liquid to be filtered through the system 34. At least one controller 68 may be operably connected to the various valves of the system 34 for programmed opening and closing of the valves in automated operation of the system 34, as hereinafter described.

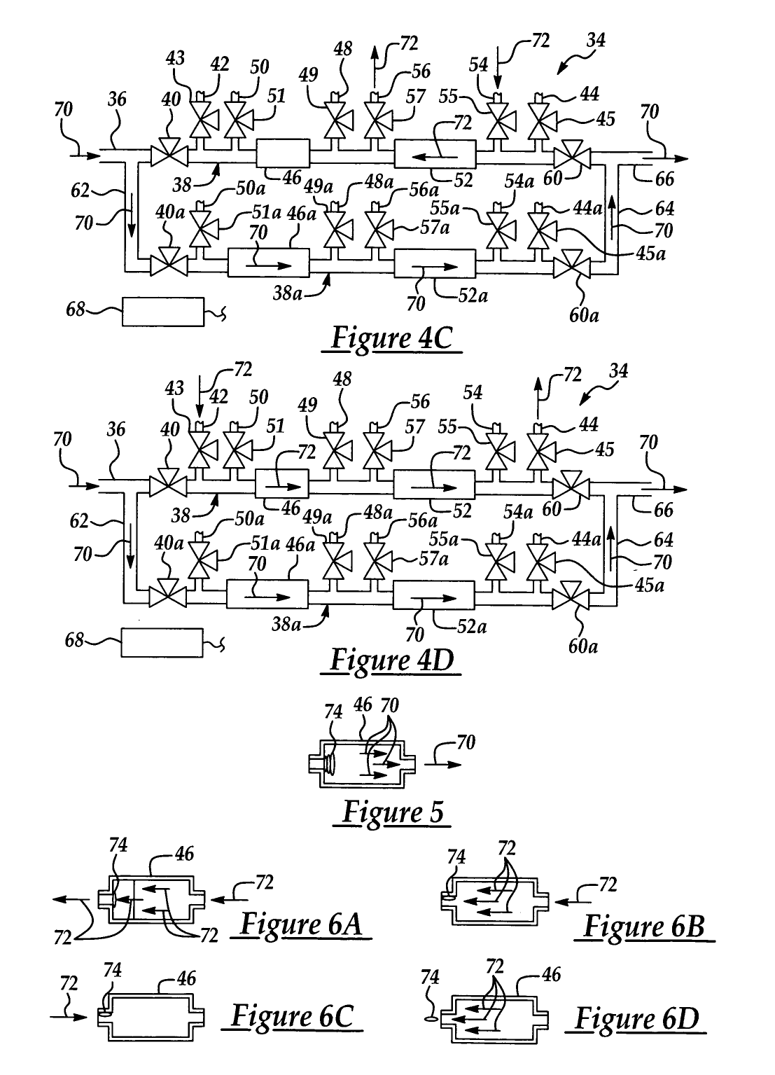

Referring next to FIGS. 4A-4D, the system 34 can be operated in one of various modes which facilitate the continuous flow of a liquid 70 from a source (not shown) to a destination while permitting cleaning or replacement of the course filters 46, 46a and fine filters 52, 52a. As the liquid 70 flows through the primary liquid delivery line 38, the course filter 46a and/or the fine filter 52a of the secondary liquid delivery line 38a can be backwashed typically using deionized water 72 (FIGS. 4A-4D), or replaced, as needed. Conversely, as the liquid 70 flows through the secondary liquid delivery line 38a, the course filter 46 and/or the fine filter 52 of the primary liquid delivery line 38 can be backwashed or replaced, as needed. Operation of the system 34 in these modes will be hereinafter described in detail.

As shown in FIG. 4A, the system 34 can be operated in a primary liquid delivery mode in which a liquid 70 is distributed through the primary liquid delivery line 38 and filtered through the course filter 46 and the fine filter 52, respectively, and then discharged through the main outlet line 66. Accordingly, the entrance valve 40 and the exit valve 60 are opened to facilitate entrance of the liquid 70 into and exit of the liquid 70 from, respectively, the primary liquid delivery line 38. The valves 43, 45, 49, 51, 55 and 57 are closed. The entrance valve 40a and the exit valve 60a are also closed to prevent flow of the liquid 70 into the secondary liquid delivery line 38a. As the liquid flows through the primary liquid delivery line 38, the course filter 46 removes course particles (not shown), whereas the fine filter 52 removes fine particles (not shown), from the liquid 70.

As shown in FIG. 4B, after the course filter 46 and/or the fine filter 52 have/has become clogged with particles due to prolonged flow of the liquid 70 through the primary liquid delivery line 38, the course filter 46 and/or the fine filter 52 is/are backwashed. This is accomplished by closing of the entrance valve 40 and the exit valve 60 to prevent further flow of the liquid 70 through the primary liquid delivery line 38. The entrance valve 40a and exit valve 60a are opened to facilitate flow of the liquid 70 instead in a secondary liquid delivery mode through the liquid shunt line 62, the secondary liquid delivery line 38a and the shunt return line 64, respectively.

As the liquid 70 flows through the secondary liquid delivery line 38a, the valves 49 and 51 are opened to facilitate flow of deionized water 72 or other cleaning fluid through the course filter inlet line 48 into the primary liquid delivery line 38. Accordingly, the water 72 flows upstream through the course filter 46 to remove particles (not shown) from the course filter 46 and distribute these particles from the primary liquid delivery line 38 through the course filter outlet line 50. Flow of the backwashing water 72 is continued for a time period of typically about 1˜30 minutes.

As shown in FIG. 4C, the fine filter 52 is backwashed in similar fashion, by closing of the valves 49, 51 and opening of the valves 55, 57. This facilitates flow of deionized water 72 through the fine filter inlet line 54, the primary liquid delivery line 38, the fine filter 52 and the fine filter outlet line 56, respectively. Accordingly, entrapped particles are removed from the fine filter 52 and flow with the water 72 from the primary liquid delivery line 38, through the fine filter outlet line 56. As during backwashing of the course filter 46 (described herein above with respect to FIG. 4B), liquid 70 continues to flow through the secondary liquid delivery line 38a, the course filter 46a and the fine filter 52a during backwashing of the fine filter 52.

As shown in FIG. 4D, the primary liquid delivery line 38 may be subjected to a purification step after backwashing of the course filter 46 and/or the fine filter 52. The purification step removes from the primary liquid delivery line 38, particles which were dislodged from the course filter 46 and/or fine filter 52 during the previous backwashing step or steps. Accordingly, the valves 43 and 45 are opened to facilitate flow of deionized water 72 or other cleaning fluid through the purification inlet line 42, primary liquid delivery line 38, course filter 46, fine filter 52 and purification outlet line 44, respectively. This flow of the water 72 is continued for a time period of typically about 1˜5 minutes. Simultaneously, the liquid 70 continues to be distributed through the secondary liquid delivery line 38a, the course filter 46a and the fine filter 52a.

After it is purified, the primary liquid delivery line 38 is set to resume flow of the liquid 70 through the primary liquid delivery line 38. During this time, the course filter 46a and fine filter 52a of the secondary liquid delivery line 38b are backwashed with deionized water 72 or other cleaning fluid, typically in the same manner as heretofore described with respect to the course filter 46 and the fine filter 52, in order to remove entrapped particles from the course filter 46a and fine filter 52a. The course filter inlet line 48a and course filter outlet line 50a are used to backwash the course filter 46a, whereas the fine filter inlet line 54a and the fine filter outlet line 56a are used to backwash the fine filter 52a. Purification of the secondary liquid delivery line 38a may be accomplished by the introduction of deionized water 72 or cleaning fluid into the line 38a through the course filter outlet line 50a, by opening of the valve 51a; and from the line 38a through the purification outlet line 44a, by opening of the valve 45a.

Referring next to FIGS. 5-6D, dislodging of entrapped particles from the course filter 46 by operation of the system 34, is shown. As shown in FIG. 5, the liquid 70 normally flows through the course filter 46, causing the entrapment of clogging particles 74 from the liquid 70, in the filter 46. As shown in FIGS. 6A and 6B, during the filter backwash cycle, deionized water 72 or other cleaning fluid flows through the course filter 46, dislodging and removing all or most of the clogging particles 74 from the filter 46. As shown in FIG. 6C, subsequent forward flow of water 72 through the filter 46 during the purification step facilitates the removal of additional particles 74 from the filter 46. As shown in FIG. 6D, after the purification step, the backwash step may be repeated, as needed, to remove any remaining entrapped particles 74 from the filter 46.

Referring again to FIGS. 4A-4D, the primary liquid delivery mode of FIG. 4A and the secondary liquid delivery mode, filter backwash cycles and purification mode of FIGS. 4B-4D, as well as the corresponding filter backwash cycles and purification mode for the course filter 46a and fine filter 52a of the secondary liquid delivery line 38a, can be automated, as desired, by operation of the controller or controllers 68. Accordingly, the controller 68 is programmed to switch the liquid delivery route from the primary liquid delivery line 38 to the secondary liquid delivery line 38a prior to excessive clogging of the course filter 46 and/or the fine filter 52; backwash the filters 46, 52, 46a and 46b, respectively; standby for the purification step; implement the purification mode for the primary liquid delivery line 38 or secondary liquid delivery line 38a; and resume delivery of the liquid 70 through the purified line 38 or 38a. The controller or controllers 68 may further be programmed to control the duration of each step, which will vary depending on such parameters as the type of liquid to be filtered; the particle concentration or distribution in the liquid; the liquid flow rate and pressure; and the type of filters.

While the preferred embodiments of the invention have been described above, it will be recognized and understood that various modifications can be made in the invention and the appended claims are intended to cover all such modifications which may fall within the spirit and scope of the invention.

What is claimed is:

1. A continuous liquid delivery system comprising:
a liquid source line;
at least one primary filter provided in fluid communication with said liquid source line for receiving a liquid from said liquid source line;
at least one secondary filter provided in fluid communication with said liquid source line for alternatively receiving the liquid from said liquid source line;
at least one primary backwash circuit provided in fluid communication with said at least one primary filter for backwashing said at least one primary filter, respectively; and
at least one secondary backwash circuit provided in fluid communication with said at least one secondary filter for backwashing said at least one secondary filter, respectively.

2. The system of claim 1 wherein said at least one primary filter comprises a course primary filter and a fine primary filter and wherein said at least one primary backwash circuit comprises a first primary backwash circuit for backwashing said course primary filter and a second primary backwash circuit for backwashing said fine primary filter.

3. The system of claim 1 wherein said at least one secondary filter comprises a course secondary filter and a fine secondary filter and wherein said at least one secondary backwash circuit comprises a first secondary backwash circuit for backwashing said course secondary filter and a second secondary backwash circuit for backwashing said fine secondary filter.

4. The system of claim 3 wherein said at least one primary filter comprises a course primary filter and a fine primary filter and wherein said at least one primary backwash circuit comprises a first primary backwash circuit for backwashing said course primary filter and a second primary backwash circuit for backwashing said fine primary filter.

5. The system of claim 1 further comprising a controller operably connected to said at least one primary backwash circuit and said at least one secondary backwash circuit for controlling backwashing of said at least one primary filter and said at least one secondary filter.

6. The system of claim 5 wherein said at least one primary filter comprises a course primary filter and a fine primary filter and wherein said at least one primary backwash circuit comprises a first primary backwash circuit for backwashing said course primary filter and a second primary backwash circuit for backwashing said fine primary filter.

7. The system of claim 5 wherein said at least one secondary filter comprises a course secondary filter and a fine secondary filter and wherein said at least one secondary backwash circuit comprises a first secondary backwash circuit for backwashing said course secondary filter and a second secondary backwash circuit for backwashing said fine secondary filter.

8. The system of claim 7 wherein said at least one primary filter comprises a course primary filter and a fine primary filter and wherein said at least one primary backwash circuit comprises a first primary backwash circuit for backwashing said course primary filter and a second primary backwash circuit for backwashing said fine primary filter.

9. A continuous liquid delivery system comprising:
a liquid source line;
a primary liquid delivery line having at least one primary filter provided in fluid communication with said liquid source line for receiving a liquid from said liquid source line;
a secondary liquid delivery line having at least one secondary filter provided in fluid communication with said liquid source line for alternatively receiving the liquid from said liquid source line;
at least one primary backwash circuit provided in fluid communication with said primary liquid delivery line for backwashing said at least one primary filter, respectively; and
at least one secondary backwash circuit provided in fluid communication with said secondary liquid delivery line for backwashing said at least one secondary filter, respectively.

10. The system of claim 9 further comprising a primary entrance valve and a primary exit valve provided in said primary liquid delivery line and a secondary entrance valve and a secondary exit valve provided in said secondary liquid delivery line.

11. The system of claim 10 wherein each of said at least one primary backwash circuit comprises a primary filter inlet line having a first primary valve and a primary filter outlet line having a second primary valve provided in fluid communication with said primary liquid delivery line on respective sides of said at least one primary filter, respectively; and wherein each of said at least one secondary backwash circuit comprises a secondary filter inlet line having a first secondary valve and a secondary filter outlet line having a second secondary valve provided in fluid communication with said secondary liquid delivery line on respective sides of said at least one secondary filter, respectively.

12. The system of claim 11 further comprising a controller operably connected to said primary entrance valve, said primary exit valve, said secondary entrance valve, said secondary exit valve, said first primary valve, said second primary valve, said first secondary valve and said second secondary valve for controlling flow of the liquid through a selected one of said primary liquid delivery line and said secondary liquid delivery line and controlling backwashing of said at least one primary filter and said at least one secondary filter.

13. The system of claim 9 wherein said at least one primary filter comprises a course primary filter and a fine primary filter and wherein said at least one primary backwash circuit comprises a first primary backwash circuit for backwashing said course primary filter and a second primary backwash circuit for backwashing said fine primary filter.

14. The system of claim 13 wherein said at least one secondary filter comprises a course secondary filter and a fine secondary filter and wherein said at least one secondary backwash circuit comprises a first secondary backwash circuit for backwashing said course secondary filter and a second secondary backwash circuit for backwashing said fine secondary filter.

15. The system of claim 14 further comprising a primary entrance valve and a primary exit valve provided in said primary liquid delivery line and a secondary entrance valve and a secondary exit valve provided in said secondary liquid delivery line.

16. The system of claim 15 further comprising a controller operably connected to said primary entrance valve, said primary exit valve, said secondary entrance valve, said secondary exit valve, said at least one primary backwash circuit and said at least one secondary backwash circuit for controlling flow of the liquid through a selected one of said at least one primary filter and said at least one secondary filter and controlling backwashing of said fine primary filter, said course primary filter, said fine secondary filter and said course secondary filter.

17. A method of providing continuous delivery of a liquid, comprising the steps of:
providing at least one primary filter and at least one secondary filter;
distributing the liquid through said at least one primary filter;
shunting the liquid from said at least one primary filter to said at least one secondary filter; and
backwashing said at least one primary filter by backflow of a cleaning fluid through said at least one primary filter.

18. The method of claim 17 further comprising the steps of purifying said at least one primary filter by forward flow of a cleaning fluid through said at least one primary filter and shunting the liquid from said at least one secondary filter to said at least one primary filter.

19. The method of claim 18 further comprising the step of backwashing said at least one secondary filter by backflow of a cleaning fluid through said at least one secondary filter.

20. The method of claim 19 further comprising the steps of purifying said at least one secondary filter by forward flow of a cleaning fluid through said at least one secondary filter and shunting the liquid from said at least one primary filter to said at least one secondary filter.
